(19) United States
(12) Patent Application Publication
(10) Pub. No.: US 2024/0376801 A1
(43) Pub. Date: Nov. 14, 2024

(54) DETERMINING CARBON EMISSIONS AT A WELLBORE

(71) Applicant: Schlumberger Technology Corporation, Sugar Land, TX (US)

(72) Inventors: Ashley Bernard Johnson, Milton (GB); Syed Muhammad Fahim Ud Din, Houston, TX (US); Anna Marjatta Mäkinen, Cambridge (GB)

(21) Appl. No.: 18/687,397

(22) PCT Filed: Nov. 1, 2022
(86) PCT No.: PCT/US2022/079027

§ 371 Date: Feb. 28, 2024

Related U.S. Application Data
(60) Provisional application No. 63/274,052, filed on Nov. 1, 2021.

(51) Int. Cl. E21B 41/00; G06F 30/28

(52) U.S. Cl. CPC E21B 41/00; G06F 30/28; E21B 2200/20

(57) ABSTRACT

A carbon emissions manager receives surface drilling parameters for drilling equipment at a downhole drilling operation. Using the surface drilling parameters, the carbon emissions manager determines a power draw from a generator by the drilling equipment. The power draw is related to the diesel fuel consumed by the generator. Using the diesel fuel consumption, the carbon emissions manager determines carbon emissions for the drilling equipment.

### CROSS-REFERENCE TO RELATED APPLICATIONS

This application claims the benefit of, and priority to, U.S. Patent Application No. 63/274,052, filed Nov. 1, 2021, and titled “Determining Carbon Emissions at a Wellbore”, which application is expressly incorporated herein by this reference in its entirety.

### BACKGROUND

Many wellbores are located and drilled in remote locations that are not connected to a conventional energy grid. Wellbores are often drilled, however, using electric equipment, or equipment that operates using electric power. To provide electric power to the drilling equipment, a wellsite may include one or more generators. The generators may be powered by diesel or other fossil fuels.

Many jurisdictional regulations for industrial operations (e.g., drilling operations, mining operations, construction operations) regulate the amount of greenhouse gasses, including carbon dioxide and other greenhouse gasses that are emitted during operation. These regulations may involve the purchase, sale, and/or transfer of so-called carbon credits, or carbon dioxide emissions or carbon dioxide equivalent (CO2e) emissions. The amount of CO2e emitted by a diesel generator may be understood using a simple chemical analysis of its combustion. Conventionally, the amount of CO2e emissions produced at an industrial operation is then determined using the amount of diesel consumed.

### SUMMARY

In some embodiments, a method for tracking carbon emissions at a wellsite includes receiving surface drilling parameters used during drilling activities. The surface drilling parameters are associated with drilling equipment. Based on the surface drilling parameters, a power draw or other power consumption measurement of the drilling equipment is determined. Using the power draw, a fuel consumption rate of a generator powering the drilling equipment is determined. Based on the fuel consumption rate, a carbon emissions rate of the generator is determined. In some embodiments, the surface drilling parameters are received from a wellbore drilling model, resulting in projected carbon emissions. In some embodiments, one or more units of the drilling equipment or surface drilling parameters are adjusted. The adjusted carbon emissions are then determined and compared to the originally determined carbon emissions. The drilling operator then selects the drilling equipment and/or surface drilling parameters based at least in part on the carbon emissions.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a downhole drilling system, according to at least one embodiment of the present disclosure;

FIG. 2 is a representation of an emissions chart, according to at least one embodiment of the present disclosure;

FIG. 3 is a representation of a carbon emissions manager, according to at least one embodiment of the present disclosure;

FIG. 4 is a flowchart of a method for tracking carbon emissions at a wellsite, according to at least one embodiment of the present disclosure;

FIG. 5 is a flowchart of a method for predicting carbon emissions for a wellsite, according to at least one embodiment of the present disclosure; and

FIG. 6 is a flowchart of a method for predicting carbon emissions at a wellsite, according to at least one embodiment of the present disclosure.

### DETAILED DESCRIPTION

This disclosure generally relates to devices, systems, and methods for tracking CO2e emissions (or “carbon emissions” as used herein) at a drilling operation. A downhole drilling operation utilizes several units of downhole drilling equipment. The downhole drilling equipment may operate with one or more surface drilling parameters. The downhole drilling may track these surface drilling parameters, such as fluid flow rate, fluid pressure, weight on bit (“WOB”), torque, rotations per minute (“RPM”), rate of penetration (“ROP”), and so forth. Using the surface drilling parameters, a carbon emissions estimator may determine a power draw of the downhole drilling equipment. The power draw may be used to determine a fuel consumption by the generator, which may be converted to carbon emissions. In this manner, tracking the surface drilling parameters may allow a drilling operator to estimate the carbon emissions at any time during the drilling operation, including instantaneously during operation, after a drilling operation is complete, or before a drilling operation is begun during the planning phase. This may provide the operator with a better understanding of the carbon emissions of a drilling project.

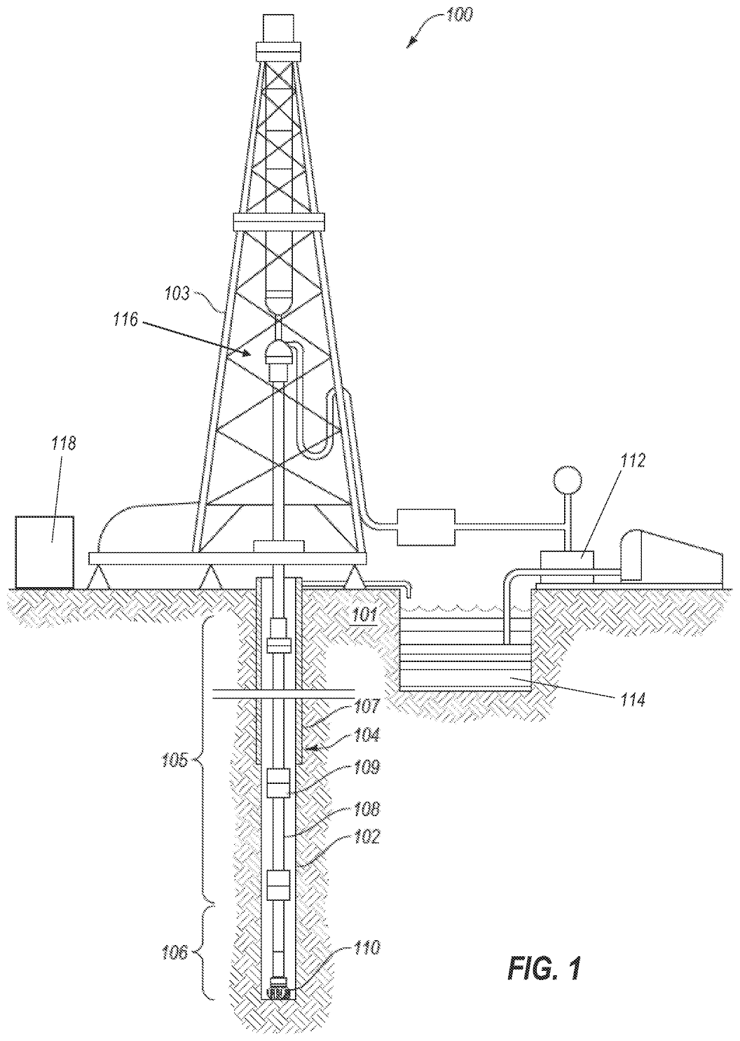

FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (“RSS”). The RSS may include directional drilling tools that change a direction of the bit 110, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface, or may be allowed to fall downhole.

Surface equipment of the drilling system 100 may be used to perform or assist in various drilling operations. For example, a mud pump 112 may pump drilling fluid from a mud pit 114 into the drill string 105. A drive 116 may support the drill string 105 and help to apply torque to the drill string 105. The surface equipment may include a “hotel,” which may include the management offices, change rooms, showers, housing, other elements related to the personnel of the drilling operation, mud plant, stirrers, compressors, hydraulic power units for rig floor equipment, winches, cranes, any other operational equipment, and combinations thereof.

Each unit of drilling equipment may receive electrical power, directly or indirectly, from one or more generators 118 located at the surface. The generators 118 may be diesel powered. Conventionally, to determine the carbon emissions of a drilling operation, an operator may measure the amount of diesel fuel consumed by the generators on a periodic basis, such as daily, weekly, monthly, and so forth. Checking the diesel consumed periodically may allow the drilling operator to determine the carbon emissions periodically but does not provide the drilling operator with detailed information regarding the diesel consumed at any particular point in time or time period between checks. Furthermore, diesel consumption does not provide any indication of the carbon emissions a particular unit of drilling equipment is responsible for.

In accordance with embodiments of the present disclosure, a unit of drilling equipment may be any unit of equipment. For example, the drilling equipment may include surface drilling equipment, such as a top drive, draw works, mud pump, any other surface drilling equipment, and combinations thereof. In some embodiments, the drilling equipment may include downhole drilling equipment, such as a mud motor, a bit, a reamer, a stabilizer, a casing cutter, any other downhole drilling equipment, and combinations thereof.

Many drilling operations include sensors that may detect one or more of the surface drilling parameters. In some embodiments, one or more sensors at the mud pump 112 and/or in the piping between the mud pump 112 and the drill string, or at any other hydraulic location, may detect drilling fluid properties of the drilling fluid. For example, one or more sensors may detect the fluid flow rate, the fluid velocity, the fluid pressure, the fluid density, the fluid viscosity, the fluid composition, any other drilling fluid property, and combinations thereof. In some embodiment, the fluid flow rate may be determined by measuring a mud pump speed, assuming a swept volume of the pump and a volumetric efficiency of the pump.

In some embodiments, one or more sensors at the drive 116 may detect one or more drill pipe conditions. For example, a sensor at the draw works may detect the amount of weight supported by the draw works, a sensor at the kelly may detect the torque applied to the drill string 105 and/or the RPM of the drill string 105.

In accordance with embodiments of the present disclosure, there may be a direct correlation between the surface drilling parameters and the power draw on the generators 118. Because the power draw, and therefore the fuel consumption, at the generators 118 is directly related to the carbon emissions, there may be a direct correlation between the surface drilling parameters and the carbon emissions. For example, a higher fluid flow pumped by the mud pump 112 may result in a higher power draw by the mud pump 112, resulting in a corresponding increase in carbon emissions resulting from operation of the mud pump 112. In some examples, a higher WOB may indicate that the draw works are supporting more of the weight of the drill string 105, thereby increasing the power draw by the draw works on the generators 118, resulting in an increase in carbon emissions.

Surface drilling parameters are often readily available at downhole drilling operations. In this manner, surface drilling parameters provide a readily available mechanism to track carbon emissions without installing additional equipment, sensors, or other elements at the drilling operation. This may help to decrease installation and operating costs of a downhole drilling operation. This may further help to decrease the complexity of downhole drilling operations.

In some embodiments, utilizing surface drilling parameters may help to increase the availability of carbon emissions data for the drilling operator. In some embodiments, a drilling operator may have a carbon emissions target for a drilling operation. The carbon emissions target may indicate a total amount of CO2e that may be emitted with the current carbon credits, permits, or other emissions target available. Because surface drilling parameters are often tracked in real time or close to real time, the drilling operator may track in real time the carbon emissions for the drilling operation. This may allow the drilling operator to determine if the drilling operation is approaching the carbon emissions target. In some embodiments, the drilling operator may make one or more changes to the drilling equipment, surface drilling parameters, or other change to adjust the amount of carbon emissions for the drilling operation.

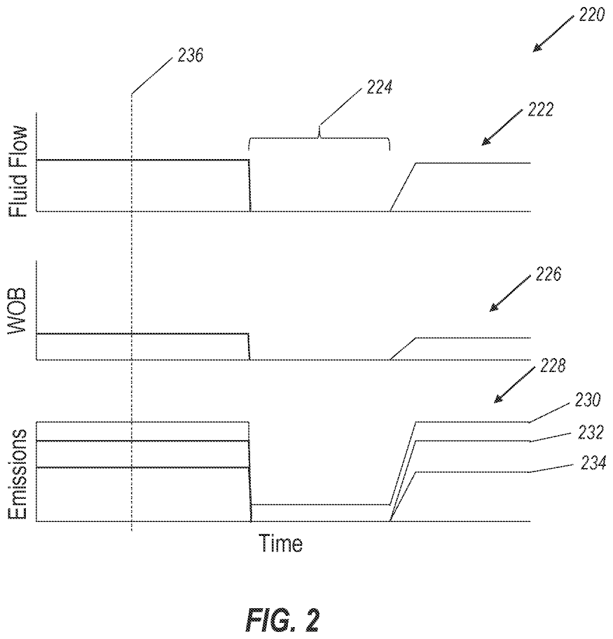

FIG. 2 is a representation of an emissions chart 220, according to at least one embodiment of the present disclosure. The emissions chart 220 shown includes a drilling fluid flow graph 222 of drilling fluid flow on the vertical axis (e.g., the y-axis) plotted against time on the horizontal axis (e.g., the x-axis). As may be seen, the drilling fluid flow may be variable across a period of time. For example, during a non-operating period 224, the drilling fluid flow stops, or reduces to zero, before starting up again. A WOB graph 226 illustrates the WOB with respect to time. Note that during the non-operating period 224, the WOB is zero or close to zero.

An emissions graph 228 illustrates the carbon emissions over time. Note that the time scale for the fluid flow graph 222, the WOB graph 226, and the emissions graph 228 is the same. The emissions graph 228 includes hotel emissions 230, WOB emissions 232, and fluid flow emissions 234, which are stacked on top of each other (e.g., a space between the WOB emissions 232 and the hotel emissions 230 is the total hotel emissions 230, and a space between the fluid flow emissions 234 and the WOB emissions 232 is the WOB emissions). As may be seen, the WOB emissions 232 are directly related to the WOB shown in the WOB graph 226 and the fluid flow emissions 234 are directly related to the fluid flow shown in the fluid flow graph 222.

During the non-operating period 224, the WOB emissions 232 and the fluid flow emissions 234 reduce to zero because the equipment is not pulling any power from the generator. The hotel emissions 230, which include emissions related to the operation of the personnel of the drilling operation, including offices, change rooms, showers, housing, and so forth, are constant or approximately constant over time.

In accordance with embodiments of the present disclosure, the instantaneous emissions of the drilling equipment may be determined at any point in time by identifying the surface drilling parameters. For example, at a point in time 236, the total emissions from the emissions graph 228 may be determined by identifying the surface drilling parameters and converting the surface drilling parameters to emissions. In some embodiments, the total emissions may be identified by locating the point in time 236 and identifying the total emissions on the emissions graph 228.

In some embodiments, the emissions for a particular unit of drilling equipment may be determined by identifying the surface drilling parameters associated with the particular unit of drilling equipment and converting them to carbon emissions. In some embodiments, the emissions for the unit of drilling equipment at the point in time 236 may be determined by referring to the generated emissions graph 228 and separating the emissions for the surface drilling parameters associated with that unit of drilling equipment.

As may be seen, the emissions for the drilling operation may be determined at any particular point in time. This may provide the drilling operator with greater detail regarding carbon emissions. As discussed herein, conventionally, carbon emissions are determined on a daily or other period basis, based on how often the total fuel consumption is measured. This may not allow the operator to understand how much carbon emissions which of the units of drilling equipment are responsible for. Tracking the emissions based on the collection of surface drilling parameters may allow the drilling operator to determine the emissions that each unit of drilling equipment is responsible for. In the embodiment shown in FIG. 2, the drilling operator may identify that, during the non-operating period 224, the only source of carbon emissions is the hotel. Because drilling operators are shut down during the non-operating period, this may allow the drilling operator to determine the cost of a shut-down in terms of carbon emissions.

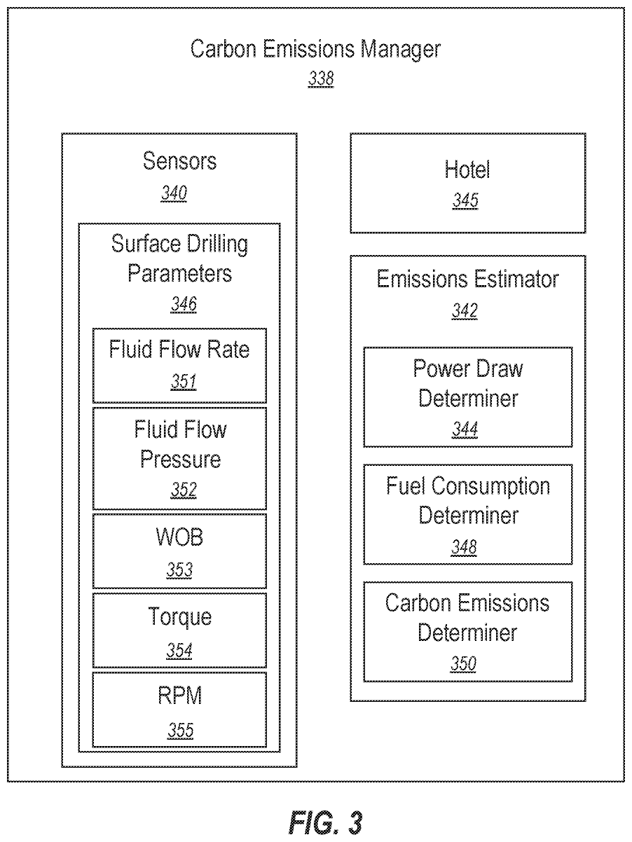

FIG. 3 is a representation of a carbon emissions manager 338, according to at least one embodiment of the present disclosure. The carbon emissions manager 338 may receive measurements from one or more sensors 340. Using the measurements from the sensors 340, an emissions estimator 342 may estimate the carbon emissions for the drilling operation. The emissions estimator 342 may include a power draw determiner 344. The power draw determiner 344 may receive surface drilling parameters 346 from the sensors 340. The power draw determiner 344 may estimate the amount power a unit of surface equipment may draw based on the associated surface drilling parameters 346. In some embodiments, the power draw determiner 344 may receive operating information for a hotel 345, which may include the power for operating support equipment, offices, change rooms, showers, housing, and other support equipment.

Using the estimated power draw for the drilling equipment, a fuel consumption determiner 348 may determine the amount of fuel that the generator may consume to power the drilling equipment. Using the fuel consumption rate, a carbon emissions determiner 350 may determine the amount of carbon that the drilling equipment may emit.

In accordance with embodiments of the present disclosure, the sensors 340 may sense surface drilling parameters 346, such as a fluid flow rate 351, fluid flow pressure 352, WOB 353, torque 354, RPM 355, any other surface drilling parameter, 346, and combinations thereof. In some embodiments, the sensors 340 may include one or more power meters installed on a unit of surface equipment. The power meter may send the power information directly to the fuel consumption determiner 348.

Each of the components of the carbon emissions manager 338 can include software, hardware, or both. For example, the components can include one or more instructions stored on a computer-readable storage medium and executable by processors of one or more computing devices, such as a client device or server device. When executed by the one or more processors, the computer-executable instructions of the carbon emissions manager 338 can cause the computing device(s) to perform the methods described herein. Alternatively, the components can include hardware, such as a special-purpose processing device to perform a certain function or group of functions. Alternatively, the components of the carbon emissions manager 338 can include a combination of computer-executable instructions and hardware.

Furthermore, the components of the carbon emissions manager 338 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

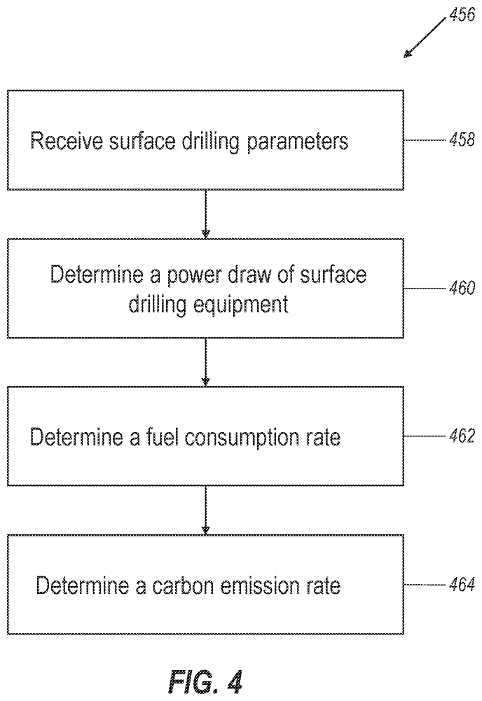

FIG. 4 is a flowchart of a method 456 for tracking carbon emissions at a wellsite, according to at least one embodiment of the present disclosure. The method 456 may include receiving surface drilling parameters that are used during drilling activities at 458. The surface drilling parameters may be associated with drilling equipment. In some embodiments, the surface drilling parameters may be directly associated with the operating of the drilling equipment. For example, the drilling fluid flow rate is directly related to the operating condition of the mud pumps. To increase the fluid flow rate, the mud pumps may need to draw more power to operate.

Based on the surface drilling parameters, a power draw of the drilling equipment may be determined at 460. As discussed herein, there is a direct relationship between the surface drilling parameters and the power draw of the drilling equipment, or the amount of power the generators generate to provide power to the drilling equipment. Based on the power draw, a carbon emissions manager may determine a fuel consumption rate of the generator that is powering the drilling equipment at 462. In some embodiments, the carbon emissions manager may determine a carbon emissions rate of the generator based on the fuel consumption rate at 464.

In some embodiments, the carbon emissions manager may provide the carbon emissions rate to a drilling operator. For example, the carbon emissions manager may display the carbon emissions rate on a graphical user interface (“GUI”) of a computing device. The drilling operator may review the carbon emissions rate on the GUI and make decisions regarding the operation of the drilling operation based on the carbon emissions rate. In some embodiments, the carbon emissions manager may display on the GUI one or more of the surface drilling parameters, the power draw, or the fuel consumption rate.

In some embodiments, the carbon emissions rate is an instantaneous carbon emissions rate. For example, the carbon emissions rate may be the instantaneous carbon emissions rate based on the most current surface drilling parameters information. In some embodiments, the carbon emissions rate may be a carbon emissions rate over a period of time. For example, the surface drilling parameters may be available or averaged over a period of time, and the carbon emissions rate may be a rate of carbon emissions over the period of time. In some embodiments, the carbon emissions rate may be a total amount of carbon emitted over the period of time.

In some embodiments, the carbon emissions rate may be a projected carbon emissions rate. For example, based on current and past surface drilling parameters, the drilling operator may determine projected surface drilling parameters. Using the projected surface drilling parameters, the drilling operator may determine a projected carbon emissions rate.

In some embodiments the drilling operator may change one or more surface drilling parameter based on the carbon emissions rate. For example, if the drilling operator determines that the carbon emissions rate is higher than a target carbon emissions rate, then the drilling operator may adjust a surface drilling parameter to reduce the carbon emissions rate. If the drilling operator determines that the carbon emissions rate is lower than a target carbon emissions rate, then the drilling operator may adjust a surface drilling parameter to increase the carbon emissions rate.

In some embodiments, the drilling operator may replace one or more of the units of drilling equipment in response to the carbon emissions rate. For example, if the carbon emissions rate is abnormally high for a given ROP in a particular formation, then the drilling operator may analyze the carbon emissions rate for the various units of drilling equipment. If one of the rates is higher than anticipated, then the drilling operator may determine that the unit of drilling equipment should be replaced.

In some embodiments, the method 456 includes determining an estimated fuel consumption over a period of time based on the fuel consumption rate. The estimated fuel consumption may be compared to a measured actual fuel consumption over the period of time at the generator. The estimated and actual fuel consumption may be compared. Based on the comparison the relationship between the surface drilling parameters and the fuel consumption may be adjusted. This may allow the drilling operator to maintain a refined model of the surface drilling parameters and fuel consumption.

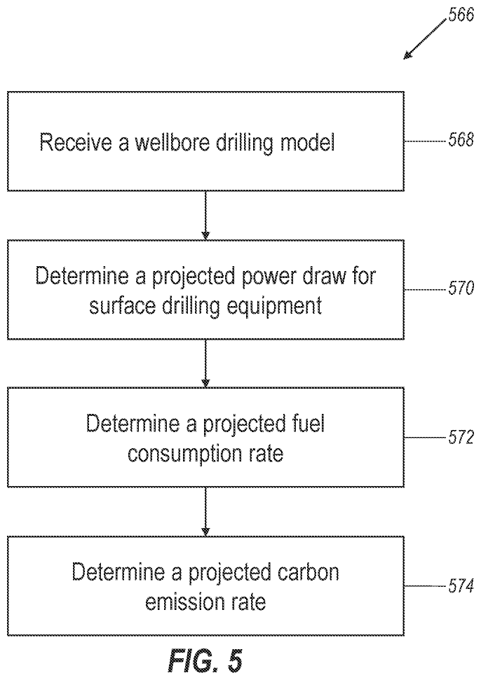

FIG. 5 is a flowchart of a method 566 for predicting carbon emissions for a wellsite, according to at least one embodiment of the present disclosure. The method 566 may include receiving a wellbore model for a target wellbore at 568. In some embodiments, the wellbore model is a wellbore drilling model, but may also be may any type of model. For example, the wellbore model may include a dynamic drilling simulation as a transient time simulation based on time or incremental rotation of the downhole drilling system. For example, the dynamic drilling simulation may include those disclosed in U.S. Pat. Nos. 6,516,293, 6,785,641, 6,873,947, 7,020,597, 7,139,689, 7,464,013, 7,693,695, 7,844,426, 8,401,831, and 9,482,055, as well as U.S. Patent Publication No. 2004/0143427, each of which is incorporated herein by this reference in its entirety.

In some embodiments, wellbore drilling model may consider at least one or more parameters, such as the curvature of the wellbore (e.g., dogleg radius, radius of curvature), the downhole tool configuration, the downhole fluid composition, the downhole formation, WOB, RPM, drilling fluid flow, any other drilling parameter, and combinations thereof. In some embodiments, the wellbore drilling model may generate projected surface drilling parameters that are projected over a period of time.

Based on the projected surface drilling parameters, a carbon emissions manager may determine a projected power draw for the drilling equipment to be used at the target wellbore at 570. Using the projected power draw, the carbon emissions manager may determine a projected fuel consumption rate over the period of time for one or more generators powering the drilling equipment to be used at the target wellbore at 572. Using the projected fuel consumption rate, the carbon emissions manager may determine a projected carbon emissions rate over the period of time at 574.

In some embodiments the method 566 may further include determining a total carbon emissions to drill the target wellbore. This may allow the drilling operator to determine the number of carbon credits to buy or to provide a cap for carbon emissions for the drilling operator to stay under during drilling operations. In some embodiments, determining the projected carbon emissions may include determining the projected carbon emissions at any time over the period of time. During actual drilling of the wellbore, the drilling operator may compare the instantaneous and/or cumulative carbon emissions against the projected carbon emissions at that point in time. If the actual and projected carbon emissions are different, the drilling operator may adjust one or more drilling parameters.

In some embodiments, determining the projected power draw included determining an equipment power draw for an individual unit of equipment of the drilling equipment. The projected fuel consumption rate may include an equipment fuel consumption rate for the individual unit of equipment based on the equipment power draw. The projected carbon emissions may then include an equipment carbon emissions for the individual unit of equipment. Providing power draw, fuel consumption, and carbon emissions for the individual unit of equipment may allow the drilling operator to determine the carbon impact each unit of equipment has on the drilling operation.

In some embodiments, the method 566 may include receiving a new wellbore drilling model. The new wellbore drilling model may include new drilling parameters, a new unit of equipment, or any other changed variable. Based on the new wellbore drilling model, the carbon emissions manager may determine a new projected power draw for the drilling equipment including the new unit of equipment. Based on the new projected power draw, a new projected fuel consumption over the period of time may be determined. Based on the new projected fuel consumption rate, a new projected carbon emissions over the period of time may be determined and compared with the original projected carbon emissions.

In accordance with embodiments of the present disclosure, a drilling operator may analyze multiple wellbore drilling models and compare their projected carbon emissions. Based, at least in part, on the comparison of the carbon emissions between the different wellbore drilling models, the drilling operator may select a combination of drilling equipment. This may allow the drilling operator to select a suite of drilling equipment based on the projected carbon emissions of the particular suite of equipment.

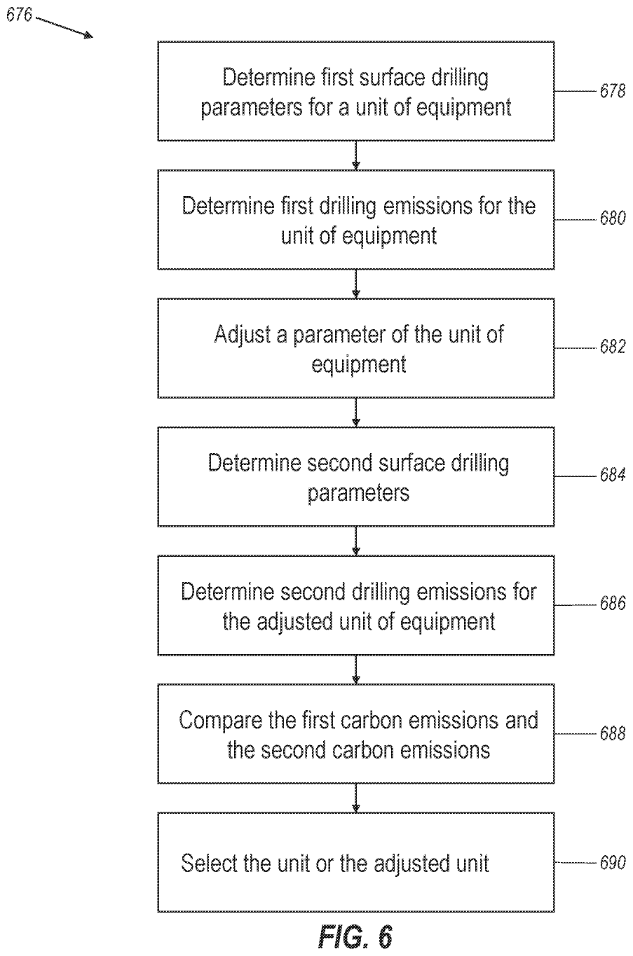

FIG. 6 is a flowchart of a method 676 for predicting carbon emissions at a wellsite, according to at least one embodiment of the present disclosure. In some embodiments, a carbon emissions manager may determine first surface drilling parameters for a unit of drilling equipment used to perform drilling operations at a wellbore at 678. Based on the first surface drilling parameters, the carbon emissions manager may determine first drilling emissions for the unit of drilling equipment at 680.

The carbon emissions may then adjust a parameter of the first unit resulting in an adjusted unit of drilling equipment at 682. Based on the adjusted parameter, the carbon emissions manager may determine second surface drilling parameters for the adjusted unit of drilling equipment at 684. Based on the second surface drilling parameters, the carbon emissions manager may determine second carbon emissions for the adjusted unit at 686. The carbon emissions manager my then compare the first carbon emissions and the second carbon emissions at 688. The method 676 may then include selecting the unit or the adjusted unit based at least in part on the comparison between the first carbon emissions and the second carbon emissions at 690.

In some embodiments, first drilling parameters and/or the second drilling parameters may be determined from a wellbore drilling model. In some embodiments, adjusting the unit includes replacing the unit with a different unit. In some embodiments, adjusting the unit includes utilizing a different surface drilling parameter in conjunction with the unit of drilling equipment.

In some embodiments, determining the surface drilling parameters includes receiving measurements of the surface drilling parameters from a sensor on the unit. In some embodiments, selecting the unit or the adjusted unit includes replacing the unit with the adjusted unit. The method 678 may further include receiving measurements using the sensor of the second drilling parameters using the adjusted unit and determining actual second drilling emissions using the measured second drilling parameters.

According to some embodiments, various methods and systems are described herein and in the claims. For example, a method can be used for tracking carbon emissions at a wellsite. The method can include feature and aspects described herein, which optionally includes any combination of: (i) receiving surface parameters (e.g., drilling or other parameters) used during operations activities (e.g., drilling, exploration, production, or installation activities), the surface parameters being associated with surface equipment (e.g., drilling, exploration, production or installation equipment); (ii) based on surface parameters, determining a power draw of the surface equipment; (iii) based on power draw, determining a fuel consumption rate of a generator powering surface equipment; (iv) determining a carbon emissions rate of a generator based on a fuel consumption rate; (v) displaying a carbon emissions rate on a GUI; (vi) determining a carbon emissions rate that is an instantaneous carbon emissions rate; (vii) comparing a carbon emissions rate to a projected carbon emissions rate; (viii) based on a carbon emissions rate, changing at least one surface parameter to adjust the carbon emissions rate; (ix) replacing a unit of surface equipment based on a carbon emissions rate; (x) determining an estimated fuel consumption over a period of time based on a fuel consumption rate; (xi) measuring actual fuel consumption over a period of time at a generator; (xii) comparing an estimated fuel consumption to an actual fuel consumption; and (xiii) adjusting a relationship between surface parameters and fuel consumption based on a comparison between estimated fuel consumption and actual fuel consumption.

Another example method can be used for predicting carbon emissions at a wellsite. The method can include feature and aspects described herein, which optionally includes any combination of: (i) receiving a wellbore model (drilling or otherwise) for a target wellbore, with the wellbore model including one or more surface parameters projected over a period of time; (ii) determining a projected power draw for surface equipment over a period of time based on one or more surface parameters; (iii) based on a projected power draw, determining a projected fuel consumption rate over a period of time for one or more generators powering surface equipment; (iv) based on a projected fuel consumption rate, determining a projected carbon emissions over a period of time; (v) displaying projected carbon emissions on a GUI; (vi) determining a total carbon emissions to drill a target wellbore; (vii) determining an equipment power draw for an individual unit of equipment of surface equipment as part of determining a projected power draw; (viii) determining an equipment fuel consumption rate for an individual unit of equipment based on an equipment power draw as part of determining projected fuel consumption rate; (ix) determining equipment carbon emissions for an individual unit of equipment as part of determining projected carbon emissions; (x) receiving a new wellbore model (e.g., drilling, maintenance, intervention, or stimulation model) incorporating a new unit of equipment; (xi) determining a new projected power draw for surface equipment including a new unit of equipment; (xii) based on a new projected power draw, determining a new projected fuel consumption rate over a period of time; (xiii) based on a new projected fuel consumption rate, determining a new projected carbon emissions over a period of time; (xiv) comparing a projected carbon emissions with a new projected carbon emissions; (xv) selecting a combination of surface drilling or other equipment based at least in part on a comparison of a projected carbon emissions with a new projected carbon emissions; and (xvi) determining an emissions rate of a projected carbon emissions at any time over a period of time as part of determining projected carbon emissions.

Another example method can be used for predicting carbon emissions at a wellsite. The method can include feature and aspects described herein, which optionally includes any combination of: (i) determining first surface drilling or other parameters for a unit of surface equipment used to perform drilling or other operations at a wellbore; (ii) based on first surface drilling or other parameters, determining first carbon emissions for a unit of surface equipment; (iii) adjusting a parameter of a unit of surface equipment resulting in an adjusted unit of surface equipment; (iv) based on an adjusted parameter, determining second surface drilling or other parameters for an adjusted unit of surface equipment; (v) based on second surface drilling or other parameters, determining a second carbon emissions of an adjusted unit of surface equipment; (vi) comparing a first carbon emissions and a second carbon emissions; (vii) selecting a unit of surface equipment or an adjusted unit of surface equipment based at least in part on a comparison between first carbon emissions and second carbon emissions; (vii) determining first surface drilling or other parameters from a wellbore drilling or other model as part of determining first surface drilling or other parameters; (viii) replacing a unit of surface equipment with a different unit as part of adjusting the unit of surface equipment; (ix) utilizing a different surface drilling or other parameter in conjunction with a unit of surface equipment as part of adjusting the unit or surface equipment; (x) receiving measurements of first surface drilling or other parameters from a sensor on a unit of surface equipment as part of determining first surface drilling or other parameters; (xi) replacing a unit of surface equipment with an adjusted unit of surface equipment as part of selecting a unit or adjusted unit of surface equipment; (xii) receiving measurements of second surface drilling or other parameters using an adjusted unit; and (xiii) using measured second carbon parameters as part of determining second carbon emissions.

Embodiments of the present disclosure also include systems that perform all or portions of methods described herein. Such systems can include surface drilling or other equipment for a wellbore or wellsite operation, as well as computers that cooperate and/or communicate with the equipment. Such computers may operate in an automated manner in some embodiments. The computers may be separate from the wellsite surface equipment, part of the wellsite surface equipment, part of downhole equipment, or be a combination of separate and embedded devices.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a computer-readable storage media and executable by one or more computing devices (e.g., any of the media content access devices described herein). In general, a processor (e.g., a microprocessor) receives instructions, from computer-readable storage medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are computer-readable storage media (devices). Computer-readable media that carry computer-executable instructions are computer-readable transmission media. Thus, by way of example, and not limitation, embodiments of the disclosure can comprise at least two distinctly different kinds of computer-readable media, namely computer-readable storage media (devices) and computer-readable transmission media.

Computer-readable storage media (devices) includes RAM, ROM, EEPROM, CD-ROM, CD-RW, solid state drives (e.g., based on RAM), flash memory, phase-change memory other types of memory, other optical disk storage, magnetic disk storage or other magnetic storage devices, or any other physical medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a computer-readable transmission medium. Computer-readable transmission media can include a network and/or data links which can be used to carry desired program code means in the form of computer-executable instructions or data structures and which can be accessed by a general purpose or special purpose computer. Combinations of computer-readable storage media and computer-readable transmission media should also be included within the scope of computer-readable media.

Further, upon reaching various computer system components, program code means in the form of computer-executable instructions or data structures can be transferred automatically from transmission media to computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable storage media at a computer system. Thus, it should be understood that computer-readable storage media can be included in computer system components that also (or even primarily) utilize computer-readable transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the present disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote computer-readable storage media.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

The embodiments of the carbon emissions manager have been primarily described with reference to wellbore drilling operations; however, the carbon emissions manager described herein may be used in applications other than the drilling of a wellbore. In other embodiments, carbon emissions managers according to the present disclosure may be used outside a wellbore or other downhole environment used for drilling, including in the exploration or production of natural resources, or in an industry that does not produce natural resources. For instance, carbon emissions managers of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. The term “may” as used in connection with embodiments disclosed herein, reflects components, features, and method steps that are included in certain embodiments but are optional and may be excluded from other embodiments of the present disclosure.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1-9. (canceled)

10. A method for predicting carbon emissions for a wellsite, comprising:
receiving a wellbore drilling model for a target wellbore, wherein the wellbore drilling model includes one or more surface drilling parameters projected over a period of time;
determining a projected power draw for drilling equipment over the period of time based on the one or more surface drilling parameters, wherein determining the projected power draw includes determining an equipment power draw for an individual unit of equipment of the drilling equipment;
based on the projected power draw, determining a projected fuel consumption rate over the period of time for one or more generators powering the drilling equipment, wherein determining the projected fuel consumption rate includes determining an equipment fuel consumption rate for the individual unit of equipment based on the equipment power draw;
based on the projected fuel consumption rate, determining a projected carbon emissions over the period of time, wherein determining the projected carbon emissions includes determining an equipment carbon emissions for the individual unit of equipment;
receiving a new wellbore drilling model incorporating a new unit of equipment;
determining a new projected power draw for the drilling equipment including the new unit of equipment;
based on the new projected power draw, determining a new projected fuel consumption rate over the period of time;
based on the new projected fuel consumption rate, determining a new projected carbon emissions over the period of time; and
comparing the projected carbon emissions with the new projected carbon emissions.

11. The method of claim 10, further comprising displaying the projected carbon emissions on a graphical user interface (GUI).

12. The method of claim 10, further comprising determining a total carbon emissions to drill the target wellbore.

13. (canceled)

14. (canceled)

15. The method of claim 10, further comprising selecting a combination of drilling equipment based at least in part on the comparison of the projected carbon emissions with the new projected carbon emissions.

16. The method of claim 15, wherein determining the projected carbon emissions includes determining an emissions rate of the projected carbon emissions at any time over the period of time.

17. A method for predicting carbon emissions at a wellsite, comprising:
determining first surface wellsite parameters for a unit of wellsite equipment used to perform wellsite operations at a wellbore;
based on the first surface wellsite parameters, determining first carbon emissions for the unit of wellsite equipment;
adjusting a parameter of the unit of wellsite equipment resulting in an adjusted unit of wellsite equipment;
based on the adjusted parameter, determining second surface wellsite parameters for the adjusted unit of wellsite equipment;
based on the second surface wellsite parameters, determining a second carbon emissions of the adjusted unit of wellsite equipment;
comparing the first carbon emissions and the second carbon emissions; and
selecting the unit of wellsite equipment or the adjusted unit of wellsite equipment based at least in part on the comparison between the first carbon emissions and the second carbon emissions.

18. The method of claim 17, wherein determining the first surface wellsite parameters includes at least one of:
determining the first surface wellsite parameters from a wellbore model; or
receiving measurements of the first surface wellsite parameters from a sensor on the unit of wellsite equipment.

19. The method of claim 17, wherein adjusting a parameter of the unit of wellsite equipment includes at least one of:
replacing the unit of wellsite equipment with a different unit of wellsite equipment; or
utilizing a different surface wellsite parameter in conjunction with the unit of wellsite equipment.

20. The method of claim 17, wherein selecting the unit of wellsite equipment or the adjusted unit of wellsite equipment includes replacing the unit of wellsite equipment with the adjusted unit of wellsite equipment, the method further comprising receiving measurements of the second surface wellsite parameters using the adjusted unit of wellsite equipment and wherein determining the second carbon emissions includes using the measurements of the second surface wellsite parameters.
